(19) United States
(12) Patent Application Publication
(10) Pub. No.: US 2003/0165701 A1
(43) Pub. Date: Sep. 4, 2003

(54) Water borne ambient temperature curable coating composition

(76) Inventor: Thomas Allen Straw, Durham (GB)

Correspondence Address: Lainie E. Parker, Intellectual Property Department, Akzo Nobel Inc., 7 Livingstone Avenue, Dobbs Ferry, NY, 10522, US

(21) Appl. No.: 10/317,831

(22) Filed: Dec. 12, 2002

Related U.S. Application Data
(60) Provisional application No. 60/360,703, filed on Mar. 1, 2002.

(30) Foreign Application Priority Data
Dec. 13, 2001 (EP) EP 01204848.4

(51) Int. Cl. B32B 27/00

(52) U.S. Cl. 428/500

(57) ABSTRACT

A water borne coating composition curable by Michael reaction comprising (A) a Michael acceptor, which is a compound or polymer containing at least two olefinic double bonds, and (B) a Michael donor, which is a compound or polymer containing at least two nucleophilic groups, wherein the Michael acceptor (A) contains doubly-activated olefinic double bonds and wherein the Michael donor (B) contains thiol groups. The coating compositions further comprise a proton acceptor and a proton donor.

This application claims priority based on European Patent Application No. 01204848.4, filed Dec. 13, 2001, and U.S. Provisional Patent Application No. 60/360,703, filed Mar. 1, 2002.

### FIELD OF THE INVENTION

The present invention relates to coating compositions curable by Michael reaction, and more in particular to coating compositions comprising (A) a Michael acceptor, which is a compound or polymer generally containing at least two activated olefinic double bonds, and (B) a Michael donor, which is a compound or polymer containing at least one and generally at least two nucleophilic groups. Coating compositions curable by Michael reaction are, in general, known from a number of references including U.S. Pat. No. 4,408,018, GB-A-2,048,913, U.S. Pat. Nos. 4,602,061, 5,084,536, 5,169,979, EP-A-697 444, U.S. Pat. Nos. 4,730,033, 4,588,807, EP-A-599 478, U.S. Pat. Nos. 5,451,653, and 5,426,156.

### BACKGROUND OF THE INVENTION

Coating compositions curable by Michael reaction have several advantages. Liquid polymers and oligomers can be cross-linked to form tough hard coatings, so that the coating composition need have little or no volatile organic solvent to achieve a viscosity suitable for spray application. The reactive groups involved in curing are less of a health and/or safety risk than most cross-linkable reactive groups. The cured materials generally are resistant to hydrolysis and degradation, particularly when the Michael donor is an activated methylene group, since the new bonds formed on cross-linking are C—C bonds. Ester linkages, such as acetoacetates, acquire greater steric hindrance and hence greater hydrolysis resistance as a result of the Michael cross-linking reaction.

The Michael reaction is beneficial to water borne systems, because it involves the transfer of hydrogen (as a proton) from a more electronegative element (with potential for hydrogen bonding) to a less electronegative element, carbon, which is not capable of hydrogen bonding. The reaction mixture therefore becomes less polar during curing, and in a coating the affinity for water should consequently decrease as curing progresses. In some cases, a water-soluble polymer/cross-linker system can be transformed into a water-resistant cured coating upon cross-linking.

Nowadays, a primary concern in the coating industry is the need to reduce the amount of energy required for curing coating compositions. This has increased the demand for compositions that cure at ambient temperature, and the Michael reaction lends itself well to this purpose. In the presence of a strong base, Michael reactions can take place at low temperatures. In general, the ingredients for these systems are formulated as two-pack systems. In EP-A-697444, a one-pack system is disclosed comprising an acrylic copolymer having a plurality of activated methylene groups, a compound having a plurality of ethylenic unsaturation, and a strong base as catalyst.

However, Michael reactions catalysed by strong bases have a tendency to suffer from acid inhibition. Carbon dioxide present in the air or an acidic substrate, for instance a wooden substrate, can severely retard or even stop cross-linking. This effect can be overcome by increasing the amount of catalyst. However, the result of increasing the amount of catalyst often is an unacceptably short pot life. Upon mixing the ingredients, the composition reacts too quickly during application or even before application. Therefore, base catalysed Michael reaction curable coating compositions have been developed which show delayed Michael reaction.

For instance, U.S. Pat. No. 4,698,406 discloses a coating composition curable by Michael reaction that comprises an amine-functional organopolysiloxane with a functionality of at least 2, and an acryl-functional organopolysiloxane with a functionality of at least 2. The composition may further contain an inhibitor, for instance a volatile acid, which delays the Michael reaction.

EP-A-161697 discloses ambient curable coating compositions comprising a polymer containing a CH group next to an ester group as Michael donor, an α,β-ethylenically unsaturated carbonyl compound as Michael acceptor, and a strong base as catalyst. Optionally, a strong acid solvent is added to retard or reduce the action of the strong base.

A drawback of these compositions that show delayed Michael reaction, however, is that they contain organic solvents. The VOC level is restricted by present day legislation, and such restriction is expected to increase in the near future.

EP 0 448 154 discloses a coating composition curable by Michael reaction that comprises a Michael acceptor with a functionality of at least 2, a Michael donor with a functionality of at least 2, and a strong basic catalyst that is blocked. The blocking agent is a carboxylic acid that is volatile or undergoes decarboxylation under curing conditions. This publication, however, does not relate to water borne systems. Another drawback of the coating compositions described in EP 0 448 154 is that due to decarboxylation of the carboxylic acid, the carbon dioxide formed during curing may get trapped and thus cause gas bubbles in the cured coating. Moreover, the curing is preferably carried out at temperatures between 60° C. and 150° C., thus resulting in increased energy costs over ambient temperature curing compositions.

Consequently, there is a need for water borne Michael curing coating compositions having a long pot life. For the purpose of the present application, pot life is defined as a 50% reduction in the film properties of the coating when tested 1 hour after application. Additionally, the water borne Michael curing coating composition should cure faster after application, particularly at ambient temperature. The combination of a long pot life and fast curing after application can be expressed as a pot life/film dry ratio.

A coating composition comprising a compound comprising one or more mercapto groups and a catalyst is disclosed in WO-A-0168736. However, this document does not relate to Michael curable coating compositions. It relates to isocyanate curing coating compositions. The coating compositions described comprise an isocyanate-functional compound, an isocyanate reactive compound comprising isocyanate reactive groups selected from mercapto groups, hydroxyl groups, and mixtures thereof. Additionally, the coating compositions comprise a phosphine and a Michael acceptor, which combination acts as co-catalyst.

### SUMMARY OF THE INVENTION

The coating composition according to the present invention provides a solution to the above-mentioned problems and disadvantages. The composition curable by Michael reaction according to the present invention is a water borne composition comprising (A) a Michael acceptor, which is a compound or polymer containing at least two olefinic double bonds, and (B) a Michael donor, which is a compound or polymer containing at least two nucleophilic groups, wherein the Michael acceptor (A) contains doubly-activated olefinic double bonds and wherein the Michael donor (B) contains thiol groups. The coating composition further comprises a proton acceptor and a proton donor.

### DETAILED DESCRIPTION OF THE INVENTION

The water borne coating composition according to the present invention is preferably cured at ambient temperature. Preferably, the composition is completely solvent-free. Optionally, small amounts of solvent may be added to the composition. Surprisingly, in comparison with most Michael reactions catalysed by strong bases, the pot life/film dry ratio is very high. The pot life/film dry ratio can be controlled by adjusting the amounts of proton donors and proton acceptors in the coating composition. This is advantageous for ease of use.

The Michael acceptor in a coating composition according to the invention is a compound or polymer containing at least two doubly-activated olefinic double bonds. Such a doubly-activated double bond can be represented by the following schematic structure:

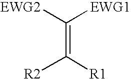

wherein R1 is an optionally substituted alkyl or aryl group, preferably isopropyl, and R2 is hydrogen. EWG1 and EWG2 are electron-withdrawing groups, for example:

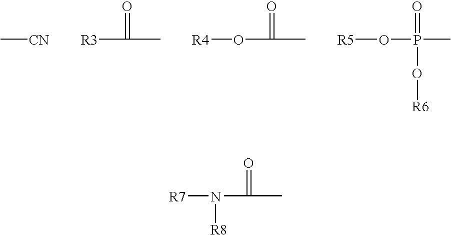

wherein R3—R8 are hydrogen, or optionally substituted alkyl or aryl groups, or linking groups optionally in a chain of repeating units.

In order to obtain a di- or polyfunctional system, the doubly-activated olefin moieties are connected to each other through either all or some combinations of EWG1, EWG2, and R1. Hence we can consider the doubly-activated moiety as being incorporated into part or all of an oligomer chain. For example:

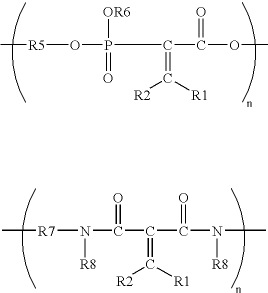

Other suitable Michael acceptors are described in U.S. Pat. No. 4,408,018. Preferably, the Michael acceptor is a di- or polyfunctional olefin-modified malonate derivative, i.e., a compound or polymer of the formula:

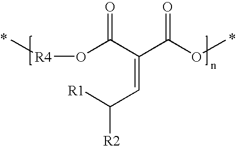

wherein n is an integer of 2 to 50, R1 is hydrogen or an alkyl or aryl group which is optionally substituted, R2 is hydrogen or an alkyl group which is optionally substituted, and R4 is an optionally substituted alkyl or aryl group, preferably an optionally substituted alkyl or aryl group having 2 to 12 carbon atoms, more preferably propyl.

The Michael acceptor can, for example, be an alkyl or arylidene malonate polyester derivative. Polyesters can be formulated using a combination of diols and polyols. More preferably, the Michael acceptor is poly(propanediol isobutylidenemalonate):

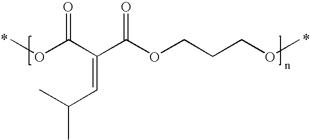

wherein n is an integer of 2 to 50.

Alternatively, the doubly-activated olefinic double bonds can be present as pendant substituents from, for example, a polymer chain. One way in which this can be achieved is with acetoacrylate-functional acrylics. Acrylic polymers can be formulated using a combination of acrylic or other vinyl monomers together with those containing the doubly-activated olefin side chain. An example of a suitable acrylic polymer is a polymer or copolymer containing groups that can be represented by the following formula:

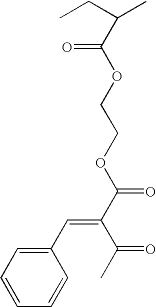

A suitable acrylic polymer may contain from two up to hundreds of groups that can be represented by the formula above. Typically, such an acrylic polymer will contain 30-40 of these groups.

The Michael donor in a coating composition according to the invention is a compound or polymer containing at least two nucleophilic groups of which at least two are thiol groups. In principle, the doubly-activated olefin component can be cured with any chemical containing two or more thiol groups. Preferably, a tetra-functional thiol is used as the Michael donor in a composition according to the invention.

One class of commercially available thiols is based on mercaptopropionate or mercapto acetate esters of diols or polyols. A typical example is pentaerythritol tetrakis (3-mercaptopropionate):

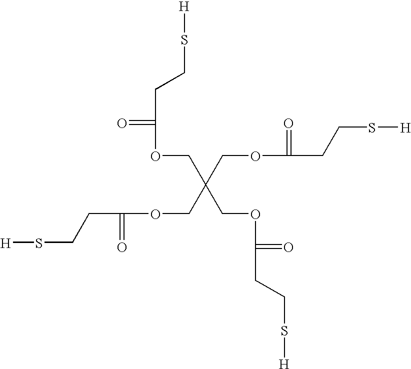

Versions of these compounds based on ethoxylated pentaerythritol are also available and may be used to offer greater dispersibility and/or miscibility with the aqueous system. Other suitable Michael donors are thiol-functional polyamide, urethane, acrylic, hydrocarbon, or silicone compounds, for instance poly(mercaptopropyl) methylsiloxane.

The coating composition according to the invention comprises a proton acceptor that catalyses the Michael reaction. The proton acceptor in a coating composition according to the invention can be incorporated into the doubly-activated olefin-containing component, i.e. the Michael acceptor. For instance, amine functionalities can be incorporated into the Michael acceptor. Alternatively, the proton donor can be added as an additive.

Preferably, the proton acceptors used are weak bases, for instance proton acceptors having a base strength of pKb 3-5. More preferred are proton acceptors having a pKb of about 4. A proton acceptor with a pKb smaller than 3 is often too weak to act as catalyst for the Michael reaction. Suitable additives are for instance tertiary aliphatic amines. Aromatic amines are less suitable because of their weaker base strength.

Especially suitable are the amines described in EP 0 114 784, which may for instance be 2,2,6,6-tetra-alkylpiperidine derivatives. These components are also known as amine light stabilisers and are very useful as proton acceptors because, besides acting as cure catalysts, they offer improved durability of the coating composition. A typical example of an amine light stabiliser is Tinuvin 292, i.e., bis (1,2,2,6,6-pentamethyl-4-piperidyl) 1,8-octane dicarboxylate:

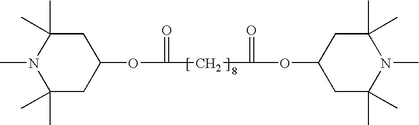

Alternatively, or in conjunction with the incorporated and/or separately added amines, the system can be rendered basic by the use of aqueous hydroxides, for example NaOH, or by the natural basicity of water borne pigment dispersions. For example, many TiO₂ products are basic in water.

The coating composition according to the invention also comprises a proton donor that inhibits the Michael reaction which is catalysed by the proton acceptor. The proton donor can be added as an additive. For example, organic acids, such as carboxylic acids, inorganic acids, such as HCl, H₂SO₄, HNO₃, or H₃PO₄, or partially organic esters of inorganic acids may be employed. Alternatively, the proton donor in a coating composition according to the invention can be incorporated either into the Michael acceptor or into the Michael donor. Examples of suitable proton donors are carboxylate or sulfonate groups and acidic functional monothiols. Besides acting as inhibitor, incorporated proton donors can render the compound or polymer into which they are incorporated water dispersible.

Preferably, the proton donors used are relatively weak acids, more preferably the proton donors have an acid strength of pKa 2-5. Examples of such proton donors are carboxylic and phosphoric derivatives. Preferably, butyl phosphoric acid is used as a proton donor because, besides acting as an inhibitor, it offers improved corrosion inhibiting properties of the coating composition. Also preferred are acidic functional monothiols which can be used for incorporation into the Michael donor or the Michael acceptor. Acidic functional monothiols are favoured because they obviate the use of a separate acid as a proton donor and of a separate dispersant for the dispersion of the binder resin.

By the use of such an acid inhibitor, base catalysts comprising Michael curing coating compositions can be prepared which have a pot life, when all components are mixed, which is much longer than the dry time of any films prepared. When the water leaves the applied film, the cure reaction proceeds more rapidly. While there is no wish to be bound by any specific theory, it seems that the effective acidity of the proton donor is reduced as water dries from the film. The acidity of the inhibitor may be enhanced by its hydration.

The coating composition can be cured at ambient temperature. Upon application of a layer of coating, the water and optional solvent in the coating composition will evaporate, and as stated above, the cure reaction proceeds more rapidly. Alternatively, the coating composition can be cured using radiation. Another alternative is to cure the coating composition at elevated temperatures, for example at a temperature between 40 and 200° C., preferably at a temperature between 75 and 150° C., more preferably at a temperature between 90 and 120° C. When curing at elevated temperatures, the amount of proton acceptor in the coating composition, which catalyses the Michael reaction, can be lower than the amount of proton acceptor used at room temperature curing.

A coating composition according to the present invention may additionally contain fillers, pigments, dyes, stabilisers, extenders, plasticisers, as well as other additives commonly used. For instance, non-ionic dispersants such as Atsurf 3969, Atlas G-1300 (ex Uniqema), and Synperionic PE/F108 (ex ICI Surfactants) may be used. Rheology modifiers such as bentones, silicas, polyurethanes, and cellulosics may be used, commercially available examples of which are Bentone® EW (ex Elementis), Bentolite® WH (ex Rockwood), Laponite® RD (ex Rockwood), HDK®-N20 (ex Wacker Chemie), NOPCO DSX-1550 (ex Cognis Corporation), and Rheolate® 425 (ex Elementis).

For the packaging of a coating composition according to the invention, preferably a two-pack composition is used. One pack contains the Michael acceptor and the other contains the Michael donor. The Michael acceptor can be either a binder resin or a cross-linker. Also the Michael donor can be either a binder resin or a cross-linker. Preferably, the first component of the two-pack coating comprises the binder resin as well as the proton acceptor, while the second component of the composition comprises the cross-linker. The proton donor can be present in either package component.

Aqueous dispersions of the binder resin and/or the cross-linker can be achieved by conventional methods, understood by those experienced in the art. For example, surfactant additives, such as polyethylene glycol, can be added to the binder resin and/or the cross-linker. A further example is to build stabilising groups, such as sulfonates, carboxylates, acidic functional monothiols, and polyethylene glycol chains, into the binder resin.

Preferably, sulfonates are built into the Michael acceptor. For example, sulfonates can be incorporated into a di- or polyfunctional olefin-modified malonate derivative. This can be done for instance by heating a mixture comprising the malonate derivative, water, sodium bisulfite, and a water-soluble alcohol such as methoxypropanol for one hour at 60° C. and for another hour at 95° C. In a next step, the volatiles should be removed, for instance under vacuum.

More preferably, both sulfonates and carboxylates are built into the Michael acceptor, which is for example a di- or polyfunctional olefin-modified malonate derivative.

The composition according to the present invention can be applied by conventional methods, including brushing, roller coating or dipping. The composition according to the invention can be used on various substrates. When applied as a primer coating, the composition is especially suitable for application on wooden substrates and metal substrates such as steel. Preferably, the composition according to the invention is used for (top)coating coated substrates.

### EXAMPLES

The invention will be elucidated with reference to the following examples. These examples are intended to illustrate the invention but are not to be construed as limiting in any manner the scope thereof.

The compounds used as starting material in the examples have the following origin:

Tinuvin 292 a liquid hindered amine light stabiliser ex Ciba Specialty Chemicals

n-butyl acid phosphate mixed mono- and diesters of phosphoric acid ex Rhodia

### Example 1

A clear coat was prepared from the following ingredients.

| | |
|---|---|
| Component | parts by weight |

Pack 1

| | |
|---|---|
| Poly (propanediol isobutylidenemalonate) | 96.50 |
| Mn˜ 1300 | |
| Base catalyst Tinuvin 292 | 6.42 |
| Butyl acid phosphate | 4.00 |
| Water | 67.19 |
| Non-ionic dispersant | 6.14 |

Pack 2

| | |
|---|---|
| Pentaerythritol tetrakis (3-mercaptopropionate) | 55.27 |
| Water | 35.06 |
| Non-ionic dispersant | 3.51 |

Water was mixed into both packs by high-speed dispersion.

A clear coat was prepared by mixing pack 1 with pack 2. The obtained clear coat was applied to shot grit blasted steel prepared to ISO 8501-1 SA3 standard at a dry film thickness of 150 μm at 24.7° C. and 40% relative humidity. The coating was allowed to dry under ambient conditions (25° C., 40% RH). The applied coating was dry in 16 hours. The pot life was 3 hours. Hence, the pot life/film dry ratio was 3:16.

### Example 2

A white paint having 60 vol. % solids was prepared from the following ingredients.

Pack 1

| Component | Parts by weight |
|---|---|
| Poly (propanediol isobutylidenemalonate) | 80.0 |
| (Mn˜ 1300) | |
| N,N-Dimethylethanolamine | 3.35 |
| 3-Mercaptopropionic acid | 6.0 |
| (pre-reacted into malonate resin) | |
| Water | 56.3 |
| Titanium dioxide pigment | 21.0 |

In preparing pack 1, the poly (propanediol isobutylidenemalonate) was modified with carboxylate. In other words, a proton donor, in this case an acid-functional monothiol, was incorporated into the Michael acceptor. Next, the remaining components present in pack 1 were added.

The carboxylate modification of the malonate using 3-mercaptopropionic acid can be performed according to method 1 or 2.

Method 1

| Reagents | |
|---|---|
| Poly (propanediol isobutylidenemalonate) | 600 g |
| 3-Mercaptopropionic acid | 45 g |
| N,N-Dimethylethanolamine | 10 g |

Procedure

The reagents are mixed together in a lined, 750 ml tin. An air-tight lid is placed on the tin, which is then placed in an oven set at 60° C. and left for 15 hours.

Method 2

| Reagents | |
|---|---|
| Poly (propanediol isobutylidenemalonate) | 600 g |
| 3-Mercaptopropionic acid | 45 g |

Procedure

The reagents are mixed together in a lined, 750 ml tin. An air-tight lid is placed on the tin, which is then placed in an oven set at 105° C. and left for 15 hours.

Pack 2

| Component | parts by weight |
|---|---|
| Pentaerythritol tetrakis (3-mercaptopropionate) | 37.8 |

Water was mixed into pack 1 by high-speed dispersion.

A clear coat was prepared by mixing pack 1 with pack 2. The obtained clear coat was applied to grit blasted steel prepared to ISO 8501-1 SA3 standard at a dry film thickness of 250 μm at 24.6° C. and 51.5% relative humidity. The coating was allowed to dry under ambient conditions (25° C., 40% RH). The applied coating was dry in 1.5 hours. The pot life was 2 hours. Hence, the pot life/film dry ratio was 4:3.

### Example 3

A white paint having 60 vol. % solids was prepared from the following ingredients.

Pack 1

| Component | Parts by weight |
|---|---|
| Poly (propanediol isobutylidenemalonate) (Mn˜ 1300) | 100.0 |
| Sodium bisulfite (pre-reacted into malonate resin) | 1.30 |
| N,N-Dimethylethanolamine | 1.25 |
| 3-Mercaptopropionic acid | 5.63 |
| (pre-reacted into malonate resin) | |
| Water | 100.0 |
| Titanium dioxide pigment | 25.0 |
| Thickener | 0.4 |

In preparing pack 1, the poly (propanediol isobutylidenemalonate) was modified with carboxylate and with sulfonate. Next, the remaining components present in pack 1 were added.

The carboxylate modification of the Michael acceptor can be performed according to the above-described method 1 or 2. The incorporation of sulfonate groups into the Michael acceptor using sodium bisulfite can be performed according to method 3.

Method 3

Reagents

| | | |
|---|---|---|
| Poly (propanediol isobutylidenemalonate) | 450 | g (2.11 mole |
| | | equivalents |
| | | olefin) |
| 2-Methoxypropanol | 37 | g |
| Sodium bisulfite (as Na₂S₂O₃) | 21.39 | g (10.66 mole |
| | | equivalents) |
| Distilled water | 43 | ml |

Apparatus

The apparatus comprises a 1-litre resin kettle with a 4-port lid (central stirrer port plus three other access ports). This is heated using a standard mantle with temperature controller and fitted out as follows:

An overhead stirrer with the stirrer shaft positioned through the centre neck; the thermocouple probe for the mantle temperature controller in one side neck (this must reach down to just above the stirrer blade), and a condenser positioned in another side neck. The remaining neck is for charging and sampling and is stoppered during processing.

Procedure

All ingredients are added to the reactor and the mixture is heated to 120° C. for 2 hours. The volatiles are then stripped under reduced pressure at 120° C. (Note: the temperature should be no higher than this, as overheating will result in degradation). The reactor is allowed to cool to 60° C. and is then discharged. Note: the product is of significantly higher viscosity than the starting resin and should be discharged whilst still warm. The reactor is then most easily cleaned by undertaking a water ‘boil-out’.

Pack 2

| Component | Parts by weight |
|---|---|
| Pentaerythritol tetrakis (3-mercaptopropionate) | 56.0 |

Water was mixed into pack 1 by high-speed dispersion.

A white coat was prepared by mixing pack 1 with pack 2. The obtained coating was applied to grit blasted steel prepared to ISO 8501-1 SA3 standard at a dry film thickness of 100 μm at 24.6° C. and 51.5% relative humidity. The coating was allowed to dry at 25° C., 50% RH. DSC on-set Tg 19° C., 60° gloss 92 units. The applied coating was dry in 16 hours. The pot life was 2 hours.

Hence, the pot life/film dry ratio was 1:8.

### Example 4

A white paint having 60 vol. % solids was prepared from the following ingredients.

Pack 1

| Component | Parts by weight |
|---|---|
| Poly (propanediol isobutylidenemalonate) | 100.0 |
| (Mn˜ 1300) | |
| Sodium bisulfite (pre-reacted into malonate resin) | 1.30 |
| Tinuvin 292 | 0.4 |
| 3-Mercaptopropionic acid | 1.0 |
| (pre-reacted into malonate resin) | |
| Water | 100.0 |
| Titanium dioxide pigment | 25.0 |
| Thickener | 0.4 |

In preparing pack 1, the poly (propanediol isobutylidenemalonate) was modified with carboxylate and with sulfonate. Next, the remaining components present in pack 1 were added.

The carboxylate modification of the Michael acceptor can be performed according to the above-described method 1 or 2. The sulfonate modification of the Michael acceptor can be performed according to the above-described method 3.

Pack 2

| Component | Parts by weight |
|---|---|
| Pentaerythritol tetrakis (3-mercaptopropionate) | 57.5 |

Water was mixed into pack 1 by high-speed dispersion.

A white coat was prepared by mixing pack 1 with pack 2. The obtained coating was applied to grit blasted steel prepared to ISO 8501-1 SA3 standard at a dry film thickness of 100 μm at 24.6° C. and 51.5% relative humidity. The coating was cured dry at 105° C. for 20 minutes to give a hard dry film. DSC on-set Tg 13° C., 60° gloss 67 units.

The pot life was 24 hours.

### Example 5

A white paint having 60 vol. % solids was prepared from the following ingredients.

Pack 1

| Component | Parts by weight |
|---|---|
| Poly (propanediol isobutylidenemalonate) | 100.0 |
| (Mn˜ 1300) | |
| Sodium bisulfite (pre-reacted into malonate resin) | 1.30 |
| Tinuvin 292 | 0.53 |
| 3-Mercaptopropionic acid | 2.0 |
| (pre-reacted into malonate resin) | |
| Water | 100.0 |
| Titanium dioxide pigment | 25.0 |
| Thickener | 0.4 |

In preparing pack 1, the poly (propanediol isobutylidenemalonate) was modified with carboxylate and with sulfonate. Next, the remaining components present in pack 1 were added.

The carboxylate modification of the Michael acceptor can be performed according to the above-described method 1 or 2. The sulfonate modification of the Michael acceptor can be performed according to the above-described method 3.

Pack 2

| Component | Parts by weight |
|---|---|
| Pentaerythritol tetrakis (3-mercaptopropionate) | 58.0 |

Water was mixed into pack 1 by high-speed dispersion.

A white coat was prepared by mixing pack 1 with pack 2. The obtained coating was applied to grit blasted steel prepared to ISO 8501-1 SA3 standard at a dry film thickness of 100 μm at 24.6° C. and 51.5% relative humidity. The coating was cured dry at 105° C. for 20 minutes to give a hard dry film. DSC on-set Tg 17° C., 60° gloss 65 units.

The pot life was 5 days.

1. A water borne coating composition curable by Michael reaction comprising (A) a Michael acceptor, which is a compound or polymer containing at least two olefinic double bonds, the Michael acceptor containing doubly-activated olefinic double bonds, (B) a Michael donor, which is a compound or polymer containing at least two nucleophilic groups, the Michael donor containing thiol groups, (C) a proton acceptor and (D) a proton donor.

2. The coating composition according to claim 1, wherein the Michael acceptor is a di- or polyfunctional olefin-modified malonate derivative.

3. The coating composition according to claim 2, wherein the malonate derivative is poly (propanediol isobutylidenemalonate).

4. The coating composition according to claim 1, wherein the Michael acceptor comprises sulfonate and/or carboxylate groups.

5. The coating composition according to claim 1, wherein the Michael donor is a tetra-functional thiol.

6. The coating composition according to claim 5, wherein the tetra-functional thiol is pentaerythritol tetrakis (3-mercaptopropionate).

7. The coating composition according to claim 1, wherein the proton acceptor is bis (1,2,2,6,6-pentamethyl-4-piperidyl) 1,8-octane dicarboxylate.

8. The coating composition according to claim 1, wherein the proton donor is butyl phosphoric acid and/or an acidic functional monothiol.

9. A process for coating a substrate, comprising applying to the substrate a composition as claimed in claim 1.

10. A coated substrate, comprising a substrate coated with the composition of claim 1.

11. A water borne coating cured by a Michael reaction between (A) a Michael acceptor, which is a compound or polymer containing at least two olefinic double bonds, the Michael acceptor containing doubly-activated olefinic double bonds, (B) a Michael donor, which is a compound or polymer containing at least two nucleophilic groups, the Michael donor containing thiol groups, (C) a proton acceptor and (D) a proton donor.
